(19) United States
(12) Patent Application Publication
(10) Pub. No.: US 2025/0200045 A1
(43) Pub. Date: Jun. 19, 2025

(54) METHOD, DEVICE, AND STORAGE MEDIUM FOR DATA REVIEWING

(71) Applicant: Beijing Youzhuju Network Technology Co., Ltd., Beijing (CN)

(72) Inventor: Tong LI, Beijing (CN)

(21) Appl. No.: 19/064,371

(22) Filed: Feb. 26, 2025

(51) Int. Cl. G06F 16/2455; G06F 16/248

(52) U.S. Cl. CPC G06F 16/2455; G06F 16/248

(57) ABSTRACT

Embodiments of the disclosure provide a solution for data reviewing. A method includes: presenting, in a data page, a first page element for locating a point of time in a timeline corresponding to an event; presenting, in the data page, a plurality of second page elements for presenting a plurality types of analysis data associated with the event; and in response to an interaction on the first page element to locate a first point of time in the timeline, presenting, in the plurality of second page elements, respective types of analysis data collected at the first point of time.

### FIELD

The disclosed example embodiments relate generally to the field of computer science, particularly to a method, device, and storage medium for data reviewing.

### BACKGROUND

More and more applications are designed to provide various services to users. In some scenarios, it is necessary to provide playback functionality for users to help them review historical data. Taking live streaming as an example, users often need to review and summarize each live streaming event, to check various analysis data about the event. Therefore, it is expected to provide a simple and intuitive way of data reviewing operations.

### SUMMARY

In a first aspect of the present disclosure, there is provided a method of data reviewing. The method includes: presenting, in a data page, a first page element for locating a point of time in a timeline corresponding to an event; presenting, in the data page, a plurality of second page elements for presenting a plurality types of analysis data associated with the event; and in response to an interaction on the first page element to locate a first point of time in the timeline, presenting, in the plurality of second page elements, respective types of analysis data collected at the first point of time.

In a second aspect of the present disclosure, there is provided an apparatus for data reviewing. The apparatus includes: a first page element presentation module, configured to present, in a data page, a first page element for locating a point of time in a timeline corresponding to an event; a second page element presentation module, configured to present, in the data page, a plurality of second page elements for presenting a plurality types of analysis data associated with the event; and an analysis data presentation module, configured to in response to an interaction on the first page element to locate a first point of time in the timeline, presenting, in the plurality of second page elements, respective types of analysis data collected at the first point of time.

In a third aspect of the present disclosure, there is provided an electronic device. The device includes at least one processing unit; and at least one memory coupled to the at least one processing unit and storing instructions executable by the at least one processing unit, the instructions, when executed by the at least one processing unit, causing the device to perform the steps of the method of the first aspect.

In a fourth aspect of the present disclosure, a non-transitory computer-readable storage medium is provided. The non-transitory computer-readable storage medium has a computer program stored thereon which, when executed by an electronic device, causes the electronic device to perform the steps of the method of the first aspect.

It should be understood that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2A illustrates a schematic diagram of an interface for data reviewing;

FIG. 2B illustrates a schematic diagram of another interface for data reviewing;

FIG. 3A illustrates a schematic diagram of an example process for data reviewing in accordance with some embodiments of the present disclosure;

FIG. 3B illustrates a schematic diagram of an example interface for metrics customization in accordance with some embodiments of the present disclosure;

FIG. 4A illustrates a schematic diagram of an example of first page element in accordance with some embodiments of the present disclosure;

FIG. 4B illustrates a schematic diagram of an example of first page element in accordance with some embodiments of the present disclosure;

FIG. 4C illustrates a schematic diagram of an example interface for metrics selection in accordance with some embodiments of the present disclosure;

FIG. 5 illustrates a flow chart of a process for data reviewing in accordance with some embodiments of the present disclosure;

FIG. 6 illustrates a block diagram of an apparatus for data reviewing in accordance with some embodiments of the present disclosure; and

FIG. 7 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it should be understood that the present disclosure may be implemented in various forms and should not be interpreted as limited to the embodiments described herein. On the contrary, these embodiments are provided for a more thorough and complete understanding of the present disclosure. It should be understood that the drawings and embodiments of the present disclosure are only for the purpose of illustration and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. As used herein, the term “model” can represent the matching degree between various data. For example, the above matching degree can be obtained based on various technical solutions currently available and/or to be developed in the future.

It should be understood that the data involved in this technical proposal (including but not limited to the data itself, data acquisition or use) shall comply with the requirements of corresponding laws, regulations and relevant provisions.

It should be understood that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It should be understood that the above notification and acquisition of user authorization process are only schematic and do not limit the embodiments of the present disclosure. Other methods that meet relevant laws and regulations may also be applied to the implementation of the present disclosure.

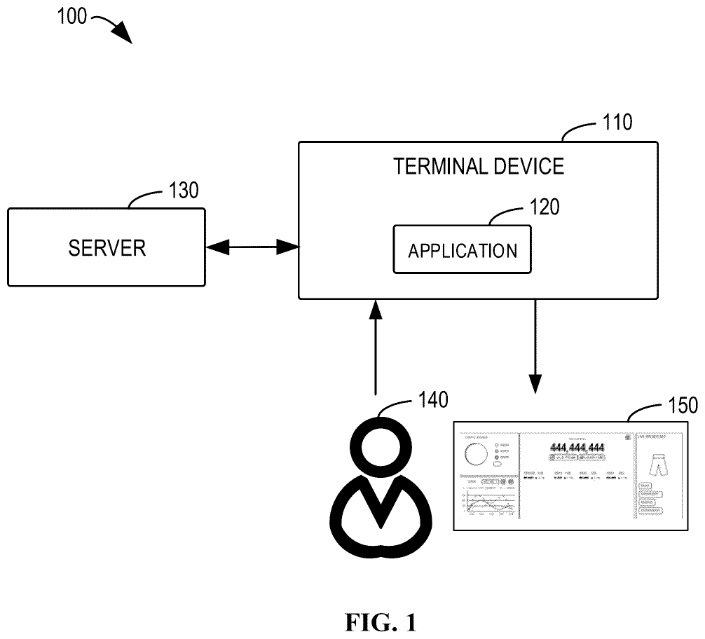

FIG. 1 illustrates a schematic diagram of an example environment 100 in which embodiments of the present disclosure can be implemented. In the example environment 100 of FIG. 1, an application 120 is installed in the terminal device 110. A user 140 may interact with the application 120 via the terminal device 110 and/or an attached device of the terminal device 110.

The application 120 may be capable of providing a service for data reviewing related to an event, such as playing or presenting various types of analysis data associated with the event. In some embodiments, the application 120 may be a backend of a live streaming application. The event may include any suitable event, such as a live streaming event, an online activity event (e.g., a big sale event for an online store), game event and the like.

In the example environment 100 of FIG. 1, if the application 120 is active, the terminal device 110 may present an interface 150 of the application 120. The interface 150 may include various types of interfaces that the application 120 can provide, such as a content presenting interface, a content creation interface, a content publishing interface, a messaging interface, a personal home interface, a data page and the like. With the corresponding interface, the application 120 may provide the user 140 with content associated with data reviewing. By appropriate means, such as clicking or selecting a page element, the application 120 may further provide the user 140 with an option to select and switch a presentation mode of the associated content.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, e-book device, gaming device, or any combination of the foregoing, including accessories and peripherals for these devices or any combination thereof. In some embodiments, the terminal device 110 can also support any type of user-specific interface (such as “wearable” circuitry). The server 130 may include various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

As mentioned above, users need to review data through the application's playback functionality. However, some applications lack playback functionality, or the data review functionality is not user-friendly enough, making it difficult for users to review historical data of certain events. Taking live streaming events as an example, users often need to review and summarize each live streaming event, such as analyzing which moment is the highlight moment, which product introduction brings the most traffic, which sales pitch has a good effect, which part of the live streaming can be done better, and so on.

It was found that most users rely on manual recording for retrospective analysis, which is costly and prone to errors. With the increase of application interface configurability, the playback functionality provided by the application can be displayed in certain interfaces and hidden in other interfaces, resulting in the lack of universality of this functionality. For example, when presenting an interface with playback functionality, historical data is presented to the user through a trend chart. For interfaces without trend charts, it is difficult for users to view the trend of historical data over time.

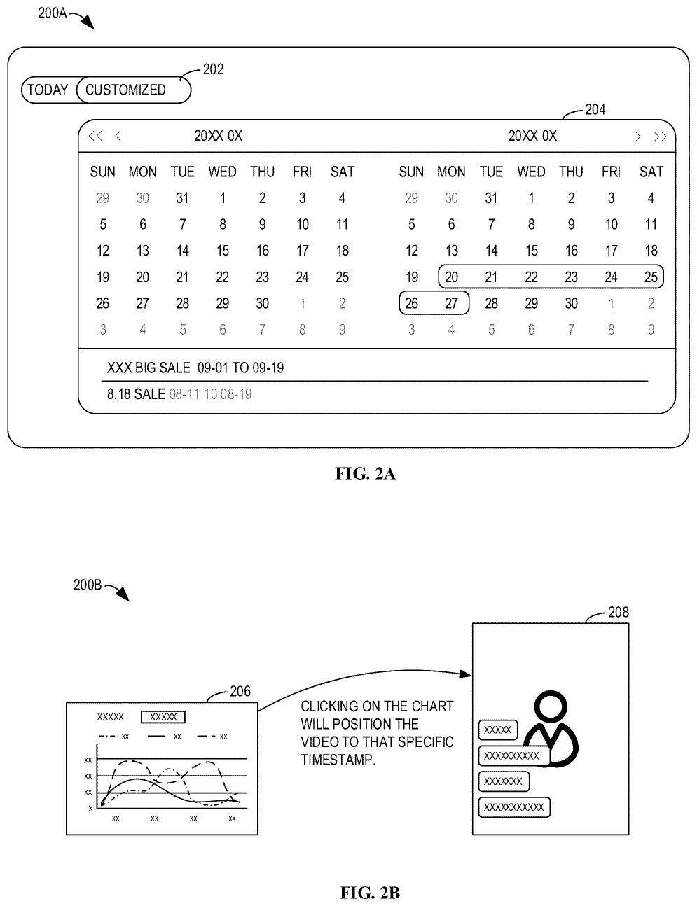

FIG. 2A illustrates a schematic diagram of an interface 200A for data reviewing. The interface 200A provided by an application includes a navigation bar control 202 and a date filter control 204. If users perform a selection “today” on the navigation bar control 202, the interface 200A may present data of today. If users perform a selection “customized” on the navigation bar control 202, the interface 200A may present the date filter control 204. The date filter control 204 provides a calendar and event reminders or comments. Users may review historical data by selecting a date duration. In such a case, the application only supports reviewing cumulative data for the selected dates. For example, if users want to review daily data, the operation is very cumbersome, and they can only view the cumulative data of the day and cannot view the dynamic changes over a continuous period of time in that date.

FIG. 2B illustrates a schematic diagram of an interface 200B for data reviewing. The interface 200B provided by an application includes a time trend chart element 206 and a video playback element 208. If users click the time trend chart element 206, the corresponding video content may be presented in the video playback element 208. That is, through the linkage of two elements, the application can support locating the video position by clicking on the time trend chart, thereby providing users with playback of historical data. However, this data playback functionality can only target specific scenarios and charts, and its universality is poor.

In view of the above issues, it is expected to provide simple, intuitive, and universal data reviewing functionalities.

According to embodiments of the present disclosure, an improved solution for data reviewing is proposed. In the solution, a first page element is presented in a data page. The first page element is configured to locate a point of time in a timeline corresponding to an event. A plurality of second page elements are presented in the data page.

The plurality of second page elements are configured to present a plurality types of analysis data associated with the event. In response to an interaction on the first page element to locate a first point of time in the timeline, respective types of analysis data collected at the first point of time are presented in the plurality of second page elements. In this way, the problems of large time granularity and low universality can be solved, thereby providing users with a new experience of dynamic data playback and global historical backtracking. The whole data reviewing process is easier and user-friendly.

In the following, some example embodiments of the present disclosure will be described in detail with reference to the accompanying drawings. It should be understood that the interfaces illustrated in the accompanying drawings are merely examples, and various user interface designs may actually exist. Individual graphical elements on the user interface may have different arrangements and different visual representations. One or more of the elements may be omitted or replaced, and one or more other elements may also be present. Embodiments of the present disclosure are not limited in this regard.

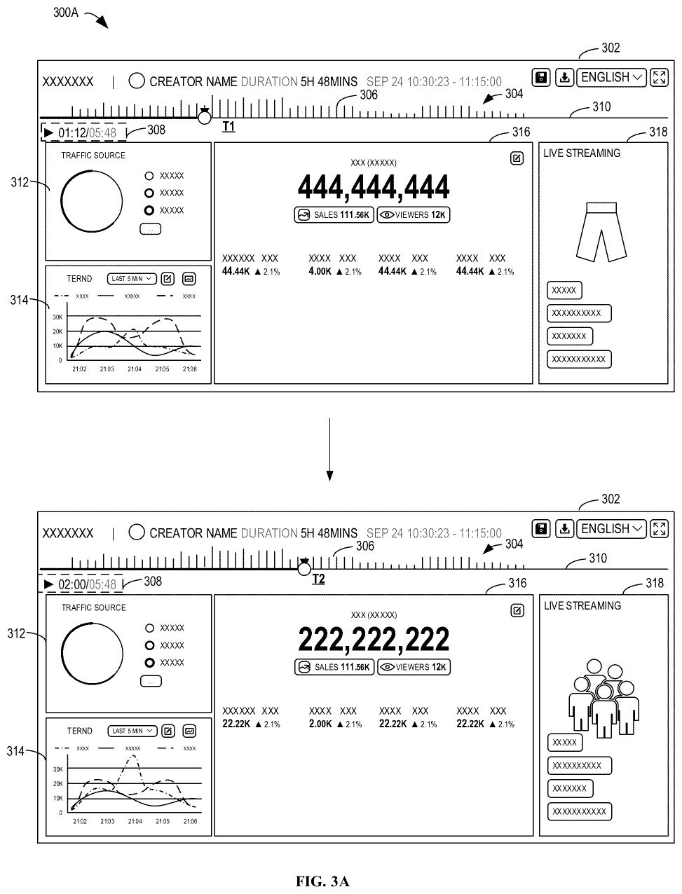

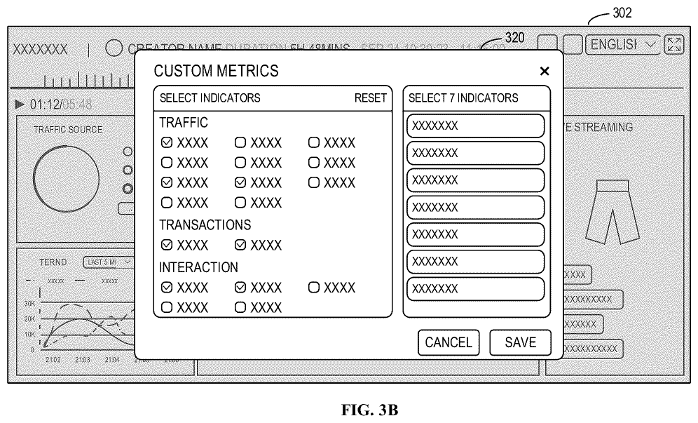

The reference is now made to FIG. 3A, which illustrates a schematic diagram of an example process 300A for data reviewing in accordance with some embodiments of the present disclosure. The process 300A involves an interface 302 (also referred to as data page). The interface 302 may be an example interface of the interface 150 provided by the application 120. In some embodiments, the interface 302 may be a dashboard user interface, for example, a dashboard user interface for a backend of an event performed in the application 120. The process 300A may be implemented at the terminal device 110, and the following will describe the details with reference to FIG. 1.

The interface 302 includes a page element 304 (also referred to as first page element). The page element 304 includes a timeline 310. The page element 304 is configured to locate a point of time in the timeline 310 corresponding to an event. For example, the timeline 310 corresponds to a duration of 5 m 48 s, which means that the event lasts 5 m 48 s.

The event may include a live stream event, an online activity event (e.g., an online activity event for an online store), or a game event. It should be understood that the event may be any suitable event, which is not limited to the present disclosure.

In some embodiments, the event may be a historical event (i.e., a completed event), and thus the timeline 310 may indicate a time range from a start of the event to an end of the event. For example, the event is a live streaming event which is completed. The timeline 310 may indicate a time rage from the start of the live streaming event to the end of the live streaming event. In this case, the interface 302 is provided for reviewing historical data associated with the event.

In some embodiments, the event may be an ongoing event, and the timeline 310 may indicate a time range from a start of the event to a current time of the event. For example, the event is a live streaming event which is ongoing. The timeline 310 may indicate a time rage from the start of the live streaming event to the current time of the live streaming event. In this case, the interface 302 is provided for reviewing real-time data associated with the event.

In some embodiments, if it is determined that the event is completed, the terminal device 110 may present the page element 304 in the interface 302. Taking a live streaming as an example, during the live streaming, the page element 304 is absent. When the live streaming is completed, the page element 304 is present. In this way, it is possible to focus on viewing the current analysis data.

The interface 302 further includes one or more page elements, such as page elements 312 to 318 (collectively or respectively referred to as second page elements). The page elements 312 to 318 are configured to present a plurality types of analysis data associated with the event. A type of analysis data may indicate or describe a certain indicator, performance metric, statistic data, video data, or any other suitable aspect of the event. Generally, the analysis data may change over time during the progress of the event. The analysis data may be presented in any suitable visual format, such as numerical values, charts, messages, comments, and/or the like. The types of analysis data may be defined based on the event. The scope of the present disclosure are not limited to the specific types of analysis data available for an event.

Taking a live streaming event as an example, the page element 312 may provide an annular chart element for displaying the proportion of each part in the overall traffic source data. As an example, the traffic from feed is 40%, the traffic from promoted is 30%, and the traffic from followers is 30%. The page element 314 may provide a line chart element that is displayed with the changes in page view (PV) data over time. As an example, three lines presented in the page element 314 represent watch PV, comment PV, and share PV, respectively. The page element 316 may provide a list chart element for displaying gross merchandise volume (GMV) data. As an example, the GMV may include created orders, paid orders, product clicks, unit price and the like. The page element 318 may provide a window element for playing a video and bullets comments for live streaming. It should be noted that there may be more or less second page elements in the interface 302 by user customization.

In some embodiments, the page elements 312 to 318 may include respective information cards for presenting the respective types of analysis data associated with the event. That is, various types of analysis data are presented in the information cards. Such information cards may be displayed in flat form or folded form, which is not limited in the present disclosure.

In some embodiments, as shown in FIG. 3B, in response to an interaction on the interface 302, the terminal device 110 may present a page element 320 to present a plurality of candidate metrics corresponding to the event. In response to a selection of at least one metric from the plurality of candidate metrics, the terminal device 110 may present, in the interface 302, a plurality of second page elements for presenting a plurality types of analysis data corresponding to the metrics selected. For example, a type of analysis data corresponds to one metric (e.g., traffic source) and is displayed in one second page element. Four types of analysis data correspond to four metrics and are displayed in four second page elements.

In FIG. 3B, the terminal device 110 may present the page element 320 to be overlaid on the interface 302. For example, in response to an interaction (e.g., a click on a button or double-click on the blank) on the interface 302, the page element 320 is presented. The page element 320 may involve multiple candidate metrics and multiple candidate indicators. As an example, through the page element 320, users may configure metrics such as traffic, transactions and interaction as the respective types of analysis data to be presented by the page elements 312 to 318. In some examples, each metric may include multiple indicators. For example, the traffic metric may include online unique visitor (UV), enter UV, leave UV and watch PV. The transactions metric may include direct GMV, product clicks, product impressions and the like. The interaction metric may include comment PV, share PV and like PV. In such a case, the user selects 7 indicators. In response to the selection, the interface 302 may be present with multiple second page elements for presenting multiple types of analysis data corresponding to the metrics and the indicators selected. For example, a type of analysis data corresponds to an indicator of one metric (e.g., traffic source) and is displayed in one second page element. Four types of analysis data correspond to two indicators of one metric and two indicators of another metric and are displayed in two second page elements. It should be noted that multiple types of analysis data may be displayed in multiple second page elements based on the metrics, the indicators or the combination thereof, which is not limited in the present disclosure.

It should be noted that page elements shown in FIGS. 3A and 3B are examples and the relevant description is for easy understanding. The analysis data to be displayed in the second page element may be determined based on specific event types, user configurations, and the like.

Referring back to FIG. 3A, in response to an interaction on the page element 304 to locate a first point of time in the timeline, the terminal device 110 presents, in the plurality of second page elements, respective types of analysis data collected at the first point of time. For example, in response to a click on the page element 304, the point of time is located at T1 (e.g., 1 m 12 s) in the timeline 310. At this point, the page elements 312 to 318 presents respective types of the analysis data collected at the point of time T1. In response to a further click on the page element 304, the point of time is located at T2 (e.g., 2 m) in the timeline 310. At this point, the page elements 312 to 318 may be presented with respective types of the analysis data collected at the point of time T2. The page element 304 allows the user to check and review the analysis data at any point of time as required, even if the event is completed.

It should be noted that any suitable interaction mode on the page element 304 is supported, including but not limited to dragging, pulling, click, double-click, long-press and the like. In this way, the dynamic data playback and global historical backtracking for the event may be implemented.

In some embodiments, the page element 304 may be pinned at a predetermined position in the interface 302. For example, as shown in FIG. 3A, the page element 304 is displayed separately and pinned on top of the interface 302. It should be noted that the page element 304 may be pinned at any suitable position in the interface 302. In this way, the page element 304 may always be presented together with the page elements 312 to 318, thereby improving universality.

In some embodiments, the page element 304 may include a playback control 308. The playback control 308 may in response to a trigger on the playback control 308, locate a point of time (e.g., T1) in the timeline 310 corresponding to the trigger. In such a case, the playback control 308 includes a certain icon, the time (e.g., 1 m 12 s) corresponding to the located point of time (e.g., T1) in the timeline 310, and the total duration (e.g., 5 m 48 s) for the timeline. It should be noted that the presentation style of the playback control 308 is not limited and any suitable presentation style is supported in the present disclosure.

The playback control 308 may, in response to a further trigger on the playback control 308, locate a point of time (e.g., T2) in the timeline 310 corresponding to the trigger. That is, the playback control 308 may be adjusted to locate different points of time in the timeline 310. In this way, the playback functionality for the event may be implemented through the playback control 308, and the time granularity may be smaller (e.g., in unit of second).

In some embodiments, in response to a trigger on the playback control 308, the playback control 308 may cause the plurality of second page elements to be presented with respective types of the analysis data collected at the located point of time. For example, in response to a click on the playback control 308, the playback functionality starts. As the time goes on, the page elements 312 to 318 may dynamically present respective types of the analysis data corresponding to each point of time. As such, the presentation content in the page elements 312 to 318 may display respective types of the analysis data may be presented in a video playback format, to show the dynamic analysis data during the progress of the event.

In some cases, in response to a further click on the playback control 308, the playback functionality stops. If the point of time is located at Tl in the timeline 310 when the playback functionality stops, the page elements 312 to 318 presents respective types of the analysis data collected at the time corresponding to T1. In response to a further click on the playback control 308, the playback functionality continues. In response to a further click on the playback control 308, the playback functionality stops, and the point of time is located at T2 in the timeline 310. At this point, the page elements 312 to 318 may present respective types of the analysis data collected at the time corresponding to T2. In this way, after triggering to play, analysis data in the second page elements would automatically change as the playback progresses.

It should be noted that any suitable trigger mode on the playback control 308 is supported, including but not limited to dragging, pulling, click, double-click, long-press and the like. For example, the timeline 310 is a part of the playback control 308. In response to a dragging on the timeline 310, the point of time in the timeline 310 is located at T1. The page element 312 is presented with traffic data at the time corresponding to T1. In response to a further dragging on the timeline 310, the point of time in the timeline 310 is located at T2. The traffic data in page element 312 is updated at the time corresponding to T2. In this way, users are allowed to pinpoint specific moments in time for detailed observation.

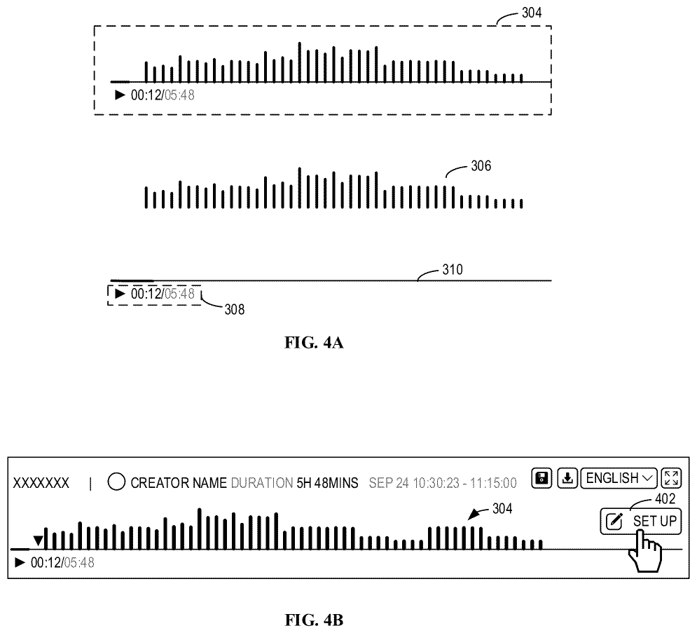

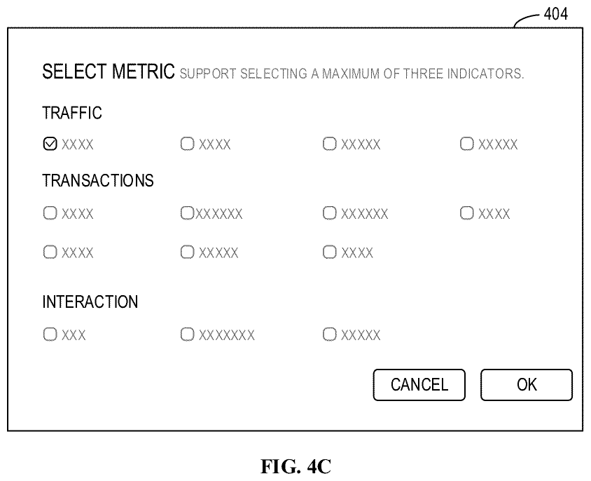

In some embodiments, the page element 304 may further include a chart element 306 to present a trend of a predetermined metric corresponding to the event along the timeline 310. FIG. 4A illustrates a schematic diagram of the page element 304 in accordance with some embodiments of the present disclosure. The page element 304 includes the timeline 310, the playback control 308 and a chart element 306. In such a case, the chart element 306 includes a histogram. It should be noted that the presentation style of the chart element 306 is not limited and any suitable presentation style, such as line chart, bar chart, pie chart, heat map, box plot, scatter plot and the like, is supported in the present disclosure. By using visualization methods such as traffic trends and key metrics, users can quickly locate key time points and important analysis data with reference to the trend of the corresponding metric, improving analysis efficiency.

In some embodiments, the predetermined metric whose trend is presented in the page element 304 may be configurable. As shown in FIG. 4B, in response to a further interaction on the page element 304, the terminal device 110 may present a configuration control 402 for configuring the predetermined metric corresponding to the event. The further interaction for triggering presentation of the configuration control 402 may be different from the interaction for locating a point of time in the timeline. For example, the further interaction includes a hover on the page element 304. In response to the hover, the configuration control 402 is presented. In such a case, the presentation style of the configuration control 402 is a button with a text “set up”. It should be noted that the presentation style and presentation position of the configuration control 402 are not limited, and any suitable presentation style and presentation position are supported in the present disclosure.

In some embodiments, in response to a trigger on the configuration control 402, the terminal device 110 may present a page element 404 (also referred to as third page element) to present the plurality of candidate metrics corresponding to the event. In response to a selection of the predetermined metric from the plurality of candidate metrics, the terminal device 110 may present, in the chart element 306 of the page element 304, the trend for the predetermined metric along the timeline 310. FIG. 4C illustrates a schematic diagram of the interface 404 for metrics selection. The interface 404 may involve multiple candidate metrics and multiple candidate indicators. In such a case, selecting a maximum of three indicators is supported. In this way, custom metrics are provided to support users to customize and configure observation auxiliary data according to specific business needs, thereby meeting personalized analysis needs in different scenarios.

In some embodiments, the plurality of candidate metrics and indicators in the page element 404 may be the same with or different from the candidate metrics and indicators in the page element 320. For example, in order to clearly present the trend for a metric corresponding to the event along the timeline in the chart element 306, the number of candidate metrics and indicators in the page element 404 may be less than the candidate metrics and indicators in the page element 320. The page element 404 may only contain metrics and indicators for core data and suitable for presentation in a simple style.

In view of the above, according to the embodiments of the present disclosure, the page element for locating a point of time in a timeline corresponding to an event is presented independently. By using visualization methods such as traffic trends and key metrics, users can quickly locate key time points and important data segments, improving analysis efficiency. Custom metrics are provided to support users to customize and configure observation auxiliary data according to specific business needs, thereby meeting personalized analysis needs in different scenarios. In this way, the problems of insufficient time granularity, low universality and unclear data observation focus can be solved. Users are provided with new experience of dynamic data playback, global historical backtracking and custom metrics corresponding to the event. The whole data reviewing process is easier and user-friendly.

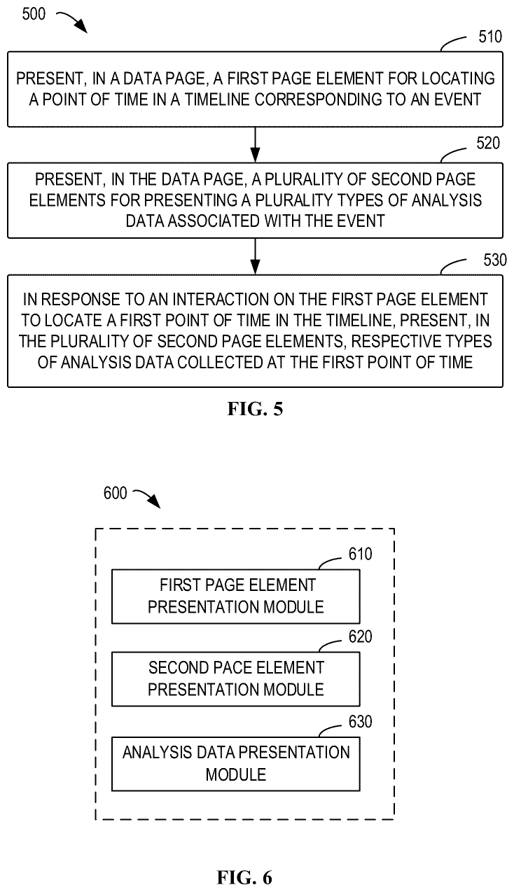

FIG. 5 illustrates a flow chart of a process 500 for data reviewing in accordance with some embodiments of the present disclosure. The process 500 can be implemented at a terminal device which operates for data reviewing. For the purpose of discussion, the process 200 will be described with reference to FIG. 1. Thus, the process 200 is implemented at the terminal device 110 of FIG. 1. In some embodiments, the operations of the terminal device 110 may be implemented or assisted by an application terminal installed in the terminal device 110, and/or by the server 130.

At block 510, the terminal device 110 presents, in a data page, a first page element for locating a point of time in a timeline corresponding to an event.

At block 520, the terminal device 110 presents, in the data page, a plurality of second page elements for presenting a plurality types of analysis data associated with the event

At block 530, the terminal device 110 in response to an interaction on the first page element to locate a first point of time in the timeline, presents, in the plurality of second page elements, respective types of analysis data collected at the first point of time.

In some embodiments of the present disclosure, the event is a historical event, and the timeline indicates a time range from a start of the event to an end of the event. Alternatively, the event is an ongoing event, and the timeline indicates a time range from a start of the event to a current time of the event.

In some embodiments of the present disclosure, the first page element includes a playback control configured to: in response to a trigger on the playback control, locate a point of time in the timeline corresponding to the trigger, and cause the plurality of second page elements to present respective types of the analysis data collected at the located point of time.

In some embodiments of the present disclosure, the first page element further includes a chart element to present a trend of a predetermined metric corresponding to the event along the timeline.

In some embodiments of the present disclosure, the method 500 includes in response to a further interaction on the first page element, presenting a configuration control for configuring the predetermined metric corresponding to the event.

In some embodiments of the present disclosure, the method 500 includes in response to a trigger on the configuration control, presenting a third page element to present a plurality of candidate metrics corresponding to the event; and in response to a selection of the predetermined metric from the plurality of candidate metrics, presenting, in the chart element of the first page element, the trend for the predetermined metric along the timeline.

In some embodiments of the present disclosure, the first page element is pinned at a predetermined position in the data page.

In some embodiments of the present disclosure, the method 500 includes in accordance with a determination that the event is completed, presenting the first page element in the data page

In some embodiments of the present disclosure, the method 500 includes in response to a further interaction on the first page element to locate a second point of time in the timeline, presenting, in the plurality of second page elements, respective types of second analysis data collected at the second point of time.

In some embodiments of the present disclosure, the plurality of second page elements include respective information cards for presenting respective types of analysis data associated with the event.

In some embodiments, the event includes a live stream event or an online activity event.

FIG. 6 illustrates a block diagram of an apparatus 600 for data reviewing in accordance with some embodiments of the present disclosure. The apparatus 600 may be implemented, for example, or included at the terminal device 110 of FIG. 1. Various modules/components in the apparatus 400 may be implemented by hardware, software, firmware, or any combination thereof.

As shown, the apparatus 600 includes a first page element presentation module 610, configured to present, in a data page, a first page element for locating a point of time in a timeline corresponding to an event. The apparatus 600 further includes a second page element presentation module 620, configured to present, in the data page, a plurality of second page elements for presenting a plurality types of analysis data associated with the event. The apparatus 600 further includes an analysis data presentation module 630, configured to in response to an interaction on the first page element to locate a first point of time in the timeline, presenting, in the plurality of second page elements, respective types of analysis data collected at the first point of time.

In some embodiments, the event is a historical event, and the timeline indicates a time range from a start of the event to an end of the event. Alternatively, the event is an ongoing event, and the timeline indicates a time range from a start of the event to a current time of the event.

In some embodiments, the first page element includes a playback control configured to: in response to a trigger on the playback control, locate a point of time in the timeline corresponding to the trigger, and cause the plurality of second page elements to present respective types of the analysis data collected at the located point of time.

In some embodiments, the first page element further includes a chart element to present a trend of a predetermined metric corresponding to the event along the timeline.

In some embodiments, the apparatus 600 further includes a configuration control presentation module, configured to in response to a further interaction on the first page element, present a configuration control for configuring the predetermined metric corresponding to the event.

In some embodiments, the configuration control presentation module is further configured to in response to a trigger on the configuration control, present a third page element to present a plurality of candidate metrics corresponding to the event; and in response to a selection of the predetermined metric from the plurality of candidate metrics, present, in the chart element of the first page element, the trend for the predetermined metric along the timeline.

In some embodiments, the first page element is pinned at a predetermined position in the data page.

In some embodiments, the first page element presentation module is configured to in accordance with a determination that the event is completed, present the first page element in the data page.

In some embodiments, the analysis data presentation module 630 is further configured to in response to a further interaction on the first page element to locate a second point of time in the timeline, present, in the plurality of second page elements, respective types of second analysis data collected at the second point of time.

In some embodiments, the plurality of second page elements include respective information cards for presenting respective types of analysis data associated with the event.

In some embodiments, the event includes a live stream event or an online activity event

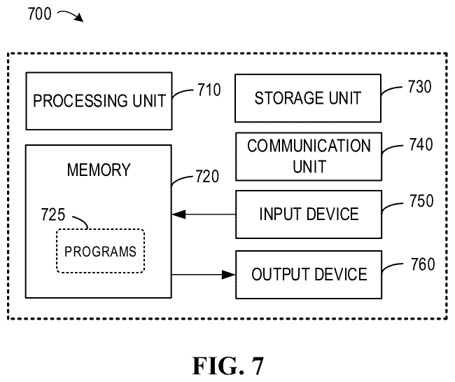

FIG. 7 illustrates a block diagram of an electronic device 700 in which one or more embodiments of the present disclosure can be implemented. It should be understood that the electronic device 700 shown in FIG. 7 is only an example and should not constitute any restriction on the function and scope of the embodiments described herein. The electronic device 700 may be used, for example, to implement the terminal device 110 of FIG. 1. The electronic device 700 may also be configured to implement the apparatus 600 of FIG. 6.

As shown in FIG. 7, the electronic device 700 is in the form of a general computing device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage medium. Such medium may be any available medium that is accessible to the electronic device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 730 may be any removable or non-removable medium, and may include a machine-readable medium, such as a flash drive, a disk, or any other medium, which can be used to store information and/or data (such as training data for training) and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 communicates with a further computing device through the communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It should be understood that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of data reviewing, comprising:
presenting, in a data page, a first page element for locating a point of time in a timeline corresponding to an event;
presenting, in the data page, a plurality of second page elements for presenting a plurality types of analysis data associated with the event; and
in response to an interaction on the first page element to locate a first point of time in the timeline, presenting, in the plurality of second page elements, respective types of analysis data collected at the first point of time.

2. The method of claim 1, wherein the event is a historical event, and the timeline indicates a first time range from a start of the event to an end of the event, or
wherein the event is an ongoing event, and the timeline indicates a second time range from the start of the event to a current time of the event.

3. The method of claim 1, wherein the first page element comprises a playback control configured to: in response to a trigger on the playback control,
locate a point of time in the timeline corresponding to the trigger, and
cause the plurality of second page elements to present respective types of the analysis data collected at the located point of time.

4. The method of claim 1, wherein the first page element further comprises a chart element to present a trend of a predetermined metric corresponding to the event along the timeline.

5. The method of claim 4, further comprising:
in response to a further interaction on the first page element, presenting a configuration control for configuring the predetermined metric corresponding to the event.

6. The method of claim 5, wherein presenting the configuration control for configuring the predetermined metric corresponding to the event comprises:
in response to a trigger on the configuration control, presenting a third page element to present a plurality of candidate metrics corresponding to the event; and
in response to a selection of the predetermined metric from the plurality of candidate metrics, presenting, in the chart element of the first page element, the trend for the predetermined metric along the timeline.

7. The method of claim 1, wherein the first page element is pinned at a predetermined position in the data page.

8. The method of claim 1, wherein presenting the first page element in the data page comprises:
in accordance with a determination that the event is completed, presenting the first page element in the data page.

9. The method of claim 1, further comprising:
in response to a further interaction on the first page element to locate a second point of time in the timeline, presenting, in the plurality of second page elements, respective types of second analysis data collected at the second point of time.

10. The method of claim 1, wherein the plurality of second page elements comprise respective information cards for presenting respective types of analysis data associated with the event.

11. An electronic device, comprising:
at least one processing unit; and
at least one memory coupled to the at least one processing unit and storing instructions executable by the at least one processing unit, the instructions, upon execution by the at least one processing unit, causing the electronic device to perform operations comprising:
presenting, in a data page, a first page element for locating a point of time in a timeline corresponding to an event;
presenting, in the data page, a plurality of second page elements for presenting a plurality types of analysis data associated with the event; and
in response to an interaction on the first page element to locate a first point of time in the timeline, presenting, in the plurality of second page elements, respective types of analysis data collected at the first point of time.

12. The electronic device of claim 11, wherein the event is a historical event, and the timeline indicates a first time range from a start of the event to an end of the event, or
wherein the event is an ongoing event, and the timeline indicates a second time range from the start of the event to a current time of the event.

13. The electronic device of claim 11, wherein the first page element comprises a playback control configured to:
in response to a trigger on the playback control, locate a point of time in the timeline corresponding to the trigger; and
cause the plurality of second page elements to present respective types of the analysis data collected at the located point of time.

14. The electronic device of claim 11, wherein the first page element further comprises a chart element to present a trend of a predetermined metric corresponding to the event along the timeline.

15. The electronic device of claim 14, wherein the operations further comprise:
in response to a further interaction on the first page element, presenting a configuration control for configuring the predetermined metric corresponding to the event.

16. The electronic device of claim 15, wherein presenting the configuration control for configuring the predetermined metric corresponding to the event comprises:
in response to a trigger on the configuration control, presenting a third page element to present a plurality of candidate metrics corresponding to the event; and
in response to a selection of the predetermined metric from the plurality of candidate metrics, presenting, in the chart element of the first page element, the trend for the predetermined metric along the timeline.

17. The electronic device of claim 11, wherein the first page element is pinned at a predetermined position in the data page.

18. The electronic device of claim 11, wherein presenting the first page element in the data page comprises:
in accordance with a determination that the event is completed, presenting the first page element in the data page.

19. The electronic device of claim 11, wherein the operations further comprise:
in response to a further interaction on the first page element to locate a second point of time in the timeline, presenting, in the plurality of second page elements, respective types of second analysis data collected at the second point of time.

20. A non-transitory computer readable storage medium having computer executable instructions stored thereon, the computer executable instructions, when executed by an electronic device, causing the electronic device to perform operations comprising:
presenting, in a data page, a first page element for locating a point of time in a timeline corresponding to an event;
presenting, in the data page, a plurality of second page elements for presenting a plurality types of analysis data associated with the event; and
in response to an interaction on the first page element to locate a first point of time in the timeline, presenting, in the plurality of second page elements, respective types of analysis data collected at the first point of time.
